(19) United States
(12) Patent Application Publication
(10) Pub. No.: US 2004/0174776 A1
(43) Pub. Date: Sep. 9, 2004

(54) Time box

(76) Inventor: Chung Chien Yang, Taipei (TW)

Correspondence Address: RABIN & BERDO, P.C., Suite 500, 1101 14 Street, N.W., Washington, DC, 20005, US

(21) Appl. No.: 10/379,558

(22) Filed: Mar. 6, 2003

(51) Int. Cl. G04B 37/00

(52) U.S. Cl. 368/276

(57) ABSTRACT

A parallelepiped time box is disclosed. The time box comprises two elongate upper bodies each including a central block of parallelepiped and two side blocks of cube; a base including three parallelepiped block means wherein a central one of the block means is recessed to form a space; a clock received in the space; and a plurality of stickers each adhered to surfaces of two adjacent block and block means, two adjacent blocks, or two adjacent block means for attaching the blocks of the upper bodies, the block means of the base, and the upper bodies and the base together. A first folding line or second folding line is formed between each pair of the adhered block and block means, the blocks, and the block means. The blocks and block means can be folded or unfolded to expose or enclose the clock.

### FIELD OF THE INVENTION

The present invention relates to clocks and more particularly to a clock which can be enclosed or opened by folding or unfolding a plurality of blocks to form a time box.

### BACKGROUND OF THE INVENTION

Clocks are well known for a long period of time. In modern times, there are a wide variety of different clocks commercially available. Conventionally, shapes are major concerns in designing clocks. Further, some clocks are formed with other articles (e.g., pieces of stationery) to be used as gifts.

However, the prior art lacks inventiveness and entertainment. As such, still very few people would like to buy a gift consisting of a clock and one or more accompanying articles. Thus, continuing improvements in the exploitation of clock are constantly being sought.

### SUMMARY OF THE INVENTION

It is therefore an object of the present invention to provide a parallelepiped time box comprising two elongate upper bodies each comprising a central block of parallelepiped and two side blocks of cube; a base comprising three parallelepiped block means wherein a central one of the block means is recessed to form a space; a clock received in the space; and a plurality of stickers each adhered to surfaces of two adjacent block and block means, two adjacent blocks, or two adjacent block means for attaching the blocks of the upper bodies, the block means of the base, and the upper bodies and the base together wherein a first folding line or second folding line is formed between each pair of the adhered block and block means, the blocks, and the block means and the blocks, and the block means are operative to fold or unfold to expose or enclose the clock. By utilizing this, a clock somewhat similar to magic cube is carried out.

The above and other objects, features and advantages of the present invention will become apparent from the following detailed description taken with the accompanying drawings.

### BRIEF DESCRIPTION OF THE DRAWINGS

FIG. 1 is a perspective view of a time box according to a preferred embodiment of the invention where clock is enclosed;

FIG. 2 is an exploded perspective view showing how to adhere stickers to blocks according to the invention;

FIG. 3 is a perspective view where the time box is opening by unfolding;

FIG. 4 is a perspective view of the time box in an open state;

FIG. 5 is a perspective view where the time box is folding to another open state; and

FIG. 6 is a perspective view where the time box has folded to another open state.

### DETAILED DESCRIPTION OF THE PREFERRED EMBODIMENTS

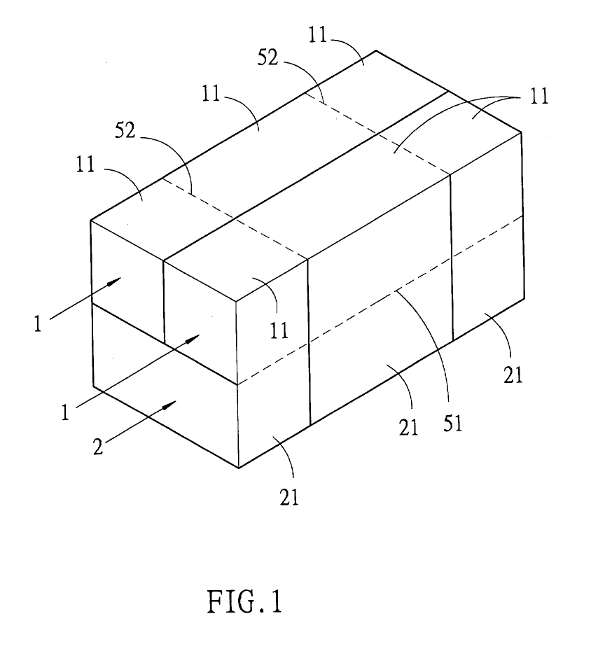

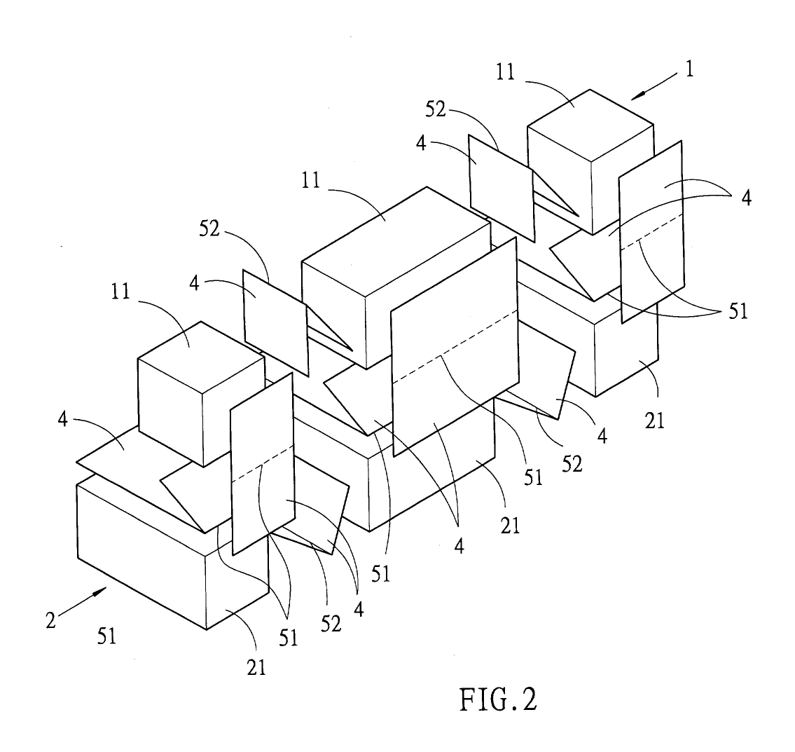

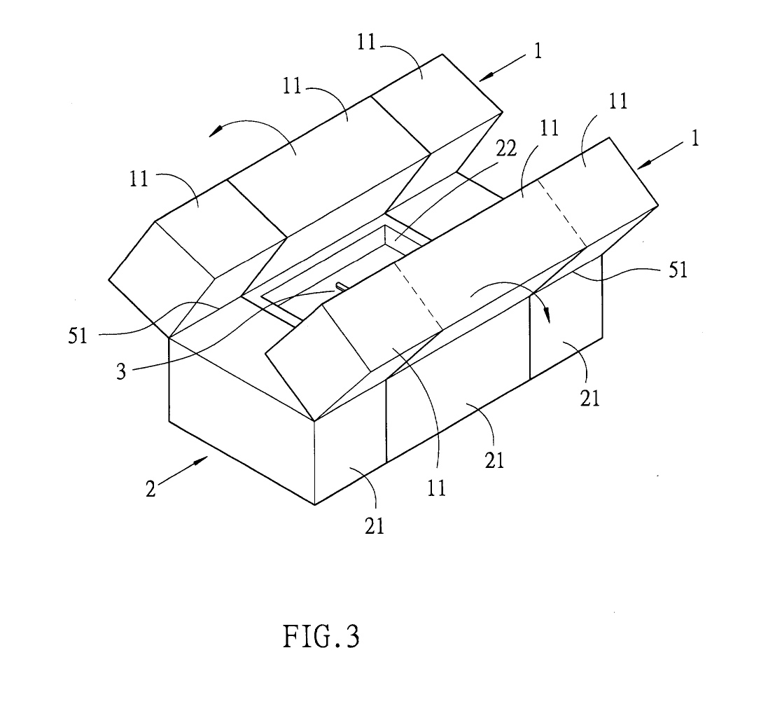

Referring to FIGS. 1, 2, 3, and 4, there is shown a parallelepiped time box constructed in accordance with the invention comprising two elongate upper bodies 1, a base 2, a clock 3, and a plurality of stickers 4. Each component is described in detail below.

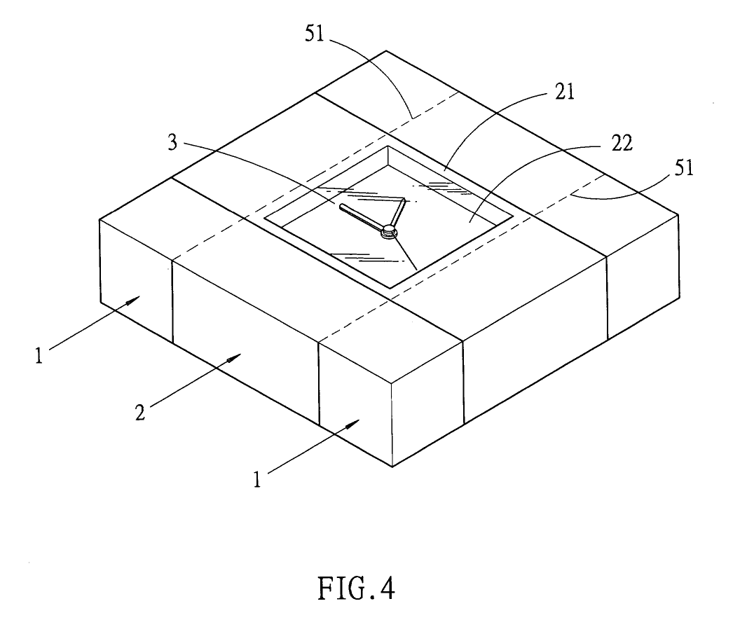

Each upper body 1 comprises three blocks 11 in which the central one is a parallelepiped and the others are cubes. The base 2 comprises three parallelepiped blocks 21 in which the central one is recessed to form a space 22 for receiving the clock 3. Each sticker 4 is adhered to surfaces of two adjacent blocks 11 and 21, two adjacent blocks 11, or two adjacent blocks 21. As such, components of the upper bodies 1, components of the base 2, and the upper bodies 1 and the base 2 all are attached together in which a folding line 51 or folding line 52 is formed between each pair of the adhered blocks 11 and 21, the blocks 11, and the blocks 21. Thus, a user can fold the blocks 11 along the folding lines 51 to place the upper body 1 on top of the base 2 for enclosing the clock 3. As shown in FIG. 1, the time box of elongate parallelepiped is formed. Alternatively, the user can unfold the blocks 11 along the folding lines 51 for extending the upper bodies 1 so as to expose the clock 3. As shown in FIG. 4, the time box of parallelepiped having square top and bottom surfaces is formed.

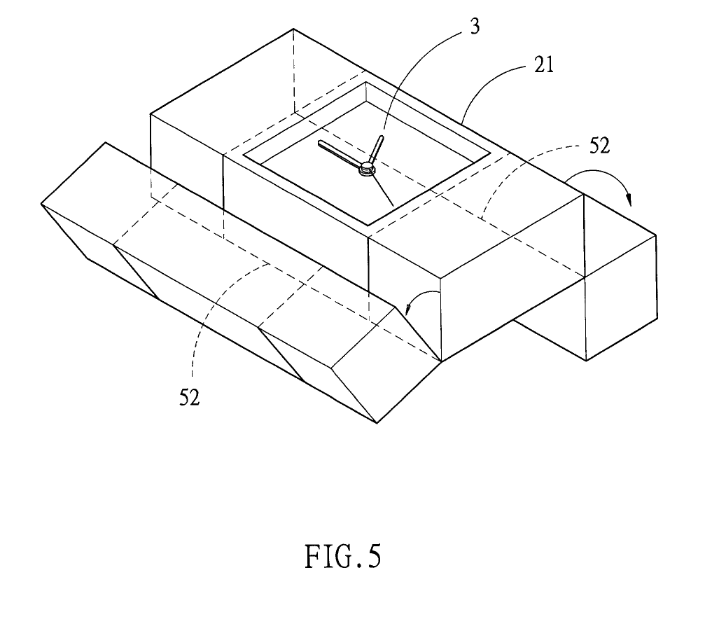

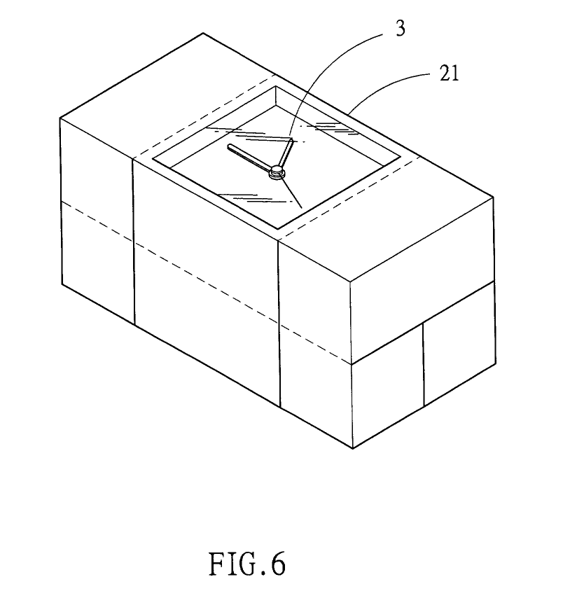

Referring to FIGS. 5 and 6, the user can fold the time box downward along the folding lines 52 for exposing the clock 3.

In view of the above, a user can fold or unfold the blocks as desired in order to expose or enclose the clock. Hence, the user can obtain more entertainment like playing a magic cube.

While the invention has been described by means of specific embodiments, numerous modifications and variations could be made thereto by those skilled in the art without departing from the scope and spirit of the invention set forth in the claims.

What is claimed is:

1. A parallelepiped time box comprising:
two elongate upper bodies each comprising a central block of parallelepiped and two side blocks of cube;
a base comprising three parallelepiped block means wherein a central one of the block means is recessed to form a space;
a clock received in the space; and
a plurality of stickers each adhered to surfaces of two adjacent block and block means, two adjacent blocks, or two adjacent block means for attaching the blocks of the upper bodies, the block means of the base, and the upper bodies and the base together,
wherein a first folding line or second folding line is formed between each pair of the adhered block and block means, the blocks, and the block means and the blocks, and the block means are operative to fold or unfold to expose or enclose the clock.
